(19) United States
(12) Patent Application Publication
(10) Pub. No.: US 2016/0200516 A1
(43) Pub. Date: Jul. 14, 2016

(54) CONTAINER HANDLING SYSTEM AND METHOD OF OPERATING CONTAINER HANDLING EQUIPMENT

(71) Applicant: SODIUM LIMITED, Albany, Auckland (NZ)

(72) Inventor: John Russell BAKER, Onehunga, Auckland (NZ)

(21) Appl. No.: 14/916,380

(22) PCT Filed: Sep. 3, 2014
(86) PCT No.: PCT/NZ2014/000187

§ 371 Date: Mar. 3, 2016

(30) Foreign Application Priority Data
Sep. 3, 2013 (NZ) 615016
Sep. 13, 2013 (NZ) 615506

(51) Int. Cl. B65G 1/137; B65G 1/04

(52) U.S. Cl. CPC B65G 1/1373; B65G 1/0485

(57) ABSTRACT

A container handling system (100) for arranging containers (4) to fulfil a plurality of orders has a conveying means (1) for receiving at least one full stack of containers, which comprise at least one container required to fulfil a first of the plurality of orders. Container separating means (26) are provided for separating the container(s) required to fulfil the first order from any excess containers. The conveying means (1) conveys the required container(s) to an output location (3). The system (100) has a container store (10), and transfer means for transferring containers between the conveying means (1) and the container store (10). A controller (30) receives the orders and controls the container separating means (26) and the transfer means. The controller (30) determines whether one or more of the excess containers are required by a subsequent order, and for any which are, selects a position in the container store (1) to store the excess containers based on a composition of the subsequent order.

This invention relates to a method and apparatus for preparing a set of containers to fulfil a plurality of orders.

Throughout this specification and claims, the word “container” is used to refer to any suitable means for holding product and may include for example, crates, boxes, tins, cartons, cases, totes, bound together product or the like and also includes a plurality of grouped containers, such as a pallet of containers or a group of bound containers.

### BACKGROUND

The term “order picking” has become associated with systems designed for receiving, storing and delivering product to and from some form of storage area. They may also use some form of warehouse management system for co-ordination of storage.

Products for distribution are often stored in a warehouse and retrieved therefrom for loading onto a vehicle for transport to customers. In an effort to increase the speed and efficiency of the storage and delivery system, apparatus for automated retrieval, or “picking”, of product from the storage space have been developed. This has represented a large advance in the efficiency of order picking systems, which traditionally heavily relied on manual handling. Further advantages of automated systems include reduced overall cost, increased accuracy and decreased risk of personal injury.

An ongoing problem faced by warehouse managers is the efficient use of space within a warehouse. Each square metre of floor space within the warehouse has an associated cost and the warehouse management system must seek to obtain the maximum use of the space in the warehouse to be efficient and competitive.

Picking systems, whether manual or automatic, typically have a defined and fixed “pick face”, or surface from which they can retrieve product. One problem presented to pick systems is how to replenish pick locations once they have been emptied. Traditionally, such replenishment is performed manually, with the assistance of a forklift or similar. This requires access to all parts of the storage area, the access channels, roads or similar requiring valuable space. Another problem faced by pick system designers is how to minimise the distance that the picking means, automated or manual has to travel to fulfil typical orders. The more the picking means has to travel, the longer the picking takes.

Due to demand variations, some products will invariably ship in greater quantities than others. Individual deliveries to customers may consist of relatively large quantities of a few products, but only a few, or even single cases or individual items of other products. This variability of product volumes presents a logistics problem in attempting to use the available resources, whether automated or manual or a combination most efficiently to obtain the best throughput.

Furthermore, the product stored in a warehouse may include a substantial variety of any given product. For example, a warehouse storage for milk will include crates containing cartons or bottles of different capacity, different flavour (e.g. conventional, chocolate, strawberry, banana, etc) and of different constituents or nutritional composition (e.g. full fat, trim, super-trim, skim, high calcium, etc). In addition, the product may be sorted by date of production. Thus, a warehouse may contain a large range of product over a wide area. Selection of the product to fill specific orders is, consequently, a complex process requiring: a) a sophisticated warehouse management system for the location of product delivered and stored, and for the selection of product for an order; and b) an efficient system for access to and removal of product from the storage area to fill an order.

Automated, robotic systems for order picking generally involve an x-y gantry system and a design for picking up individual containers or individual stacks of containers and transporting them from or to a conveyor. In the usual course, orders are delivered on pallets. Thus, the individually collected containers must then be formed into stacks of a required height, the stacks then formed into frames or partial frames of a required width and the frames or partial frames combined to form a pallet unit.

Such systems can be inefficient and/or impractical in a large warehouse environment where orders require product to be collated from many different parts of the warehouse. The robotic pickers have to cover large distances, back and forth, in the warehouse to complete a given order.

An existing automated storage and retrieval system is available from Automated Fork Truck Inc. of Salt Lake City, Utah, United States of America. This system is a storage and retrieval fork system that stores and retrieves product from vertically stacked racks. The system places product into and retrieves product from the racks through a vertical pick face at the end of a number of stacked racks and each rack being more than one pallet deep, with pallets being pushed away from the pick face for storage of another pallet in the same rack. With this system, the number of pick faces is limited and removal of individual containers from within pallets is not facilitated.

U.S. Pat. No. 6,061,607 discloses an order picking system for retrieving high volume and low volume product from two separate regions, but more specifically involves the location of product in vertical stacks in cells of totes. Low demand product is retrieved by a picker mechanism in a pick zone, by movement of that mechanism vertically above the pick zone and selection of individual articles from selected cells in selected totes. The system is primarily directed towards storage and retrieval of individual articles, which may be of high or low demand, rather than of containers containing a plurality of articles, which must, inevitably, be stored and transported in a different way.

U.S. Pat. No. 5,636,966 discloses a case picking system that removes full layers of cases and individual cases from storage towers. The storage towers are replenished from a further tower acting as a replenishment system. This requires double-handling of the transported layers. Moreover, the layers themselves are more demanding in their transport requirements than are individual cases or pallets.

International Application No. PCT/NZ2002/000008 describes an order picking system whereby product is stored in high, medium and low demand zones, with high demand product being handled in frames, medium demand product being handled in full stacks and low demand product being handled in stacks or partial stacks. This system works well, but may not make optimum use of the space available.

The reference to any prior art in this specification is not, and should not be taken as, an acknowledgement or any form of suggestion that the prior art forms part of the common general knowledge in any country.

### OBJECT OF THE INVENTION

It is an object of the present invention to provide a container handling system for arranging containers and/or a method of operating container handling equipment to fulfil a plurality of orders that efficiently uses the available footprint and/or quickly provides the necessary containers to fulfil a required order, or at least one which will provide the public with a useful choice.

Further objects of the invention may become apparent from the following description, given by way of example only.

### BRIEF SUMMARY OF THE INVENTION

According to one aspect of the present invention there is provided a container handling system for arranging containers to fulfil a plurality of orders, the system comprising:
conveying means for receiving at least one full stack of containers, the at least one stack of containers comprising at least one container required to fulfil a first of the plurality of orders;
container separating means for separating the at least one container required to fulfil the first order from any excess containers which are not required to fulfil the first order, wherein the conveying means conveys the at least one container required to fulfil the first order to an output location;
a container store, and transfer means for transferring containers between the conveying means and the container store; and
a controller for receiving the plurality of orders and controlling the container separating means and the transfer means; wherein
the controller determines whether one or more of the excess containers are required by a subsequent order, and for any excess containers which are required by the subsequent order, selects a position in the container store to store the required excess containers based on a composition of the subsequent order.

Preferably, containers are stored in the container store in rows of stacks and/or partial stacks.

Preferably, if possible, the controller directs the transfer means to store a plurality of the excess containers required for the subsequent order together in a subsequent order stack, and to store the subsequent order stack adjacent another stack comprising containers required for the same subsequent order.

Preferably,
(i) If possible, the controller directs the transfer means to store a plurality of the excess containers required for the subsequent order together in a subsequent order stack, and to store the subsequent order stack adjacent another stack comprising containers required for the same subsequent order; or
(ii) If (i) is not possible, the controller directs the transfer means to store a plurality of the excess containers required for the subsequent order together in a subsequent order stack.

Preferably,
(i) If possible, the controller directs the transfer means to store a plurality of the excess containers required for the subsequent order together in a subsequent order stack, and to store the subsequent order stack adjacent another stack comprising containers required for the same subsequent order; or
(ii) If (i) is not possible, the controller directs the transfer means to store a plurality of the excess containers required for the subsequent order together in a subsequent order stack; or
(iii) If neither (i) or (ii) are possible, the controller directs the transfer means to store at least one of the excess containers required for the subsequent order in a stack which is adjacent another stack comprising containers required for the same subsequent order.

Preferably,
(i) If possible, the controller directs the transfer means to store a plurality of the excess containers required for the subsequent order in a subsequent order stack, and to store the subsequent order stack adjacent another stack comprising containers required for the same subsequent order; or
(ii) If (i) is not possible, the controller directs the transfer means to store a plurality of the excess containers required for the subsequent order in a subsequent order stack; or
(iii) If neither (i) or (ii) are possible, the controller directs the transfer means to store at least one of the excess containers required for the subsequent order in a stack which is adjacent another stack comprising containers required for the same subsequent order; or
(iv) If neither of (i), (ii) or (iii) are possible, the controller, if possible, directs the transfer means to stack a plurality of the excess containers together which are suitable for mixing with one or more homogeneous full stacks to create at least one stack which can be stored in accordance with one of (i) to (iii).

Preferably excess containers which are not required for any of the plurality of orders are stored in the container store.

Preferably the transfer means comprises an outfeed conveyor for conveying containers out of the container store, wherein excess containers which are required for one of the plurality of orders are stored in a group, and excess containers which are not required for any of the plurality of orders are stored further away from the outfeed conveyor than excess containers which are required for one of the plurality of orders.

Preferably full stacks of excess containers which are not required for any of the plurality of orders are stored in a first zone of the container store, and partial stacks of excess containers which are not required for any of the plurality of orders are stored in a second zone of the container store along with excess containers which are required for a subsequent order, wherein the transfer means comprises a second storage zone outfeed conveyor for conveying containers out of the second zone, and wherein excess containers which are not required for any of the plurality of orders are stored further away from the outfeed conveyor than excess containers which are required for one of the plurality of orders.

Preferably the transfer means comprises a first storage zone infeed conveyor, a first storage zone outfeed conveyor and a second storage zone infeed conveyor.

Preferably the system comprises a moveable conveying means adapted to transport at least one stack or partial stack between the first storage zone infeed conveyor and the first storage zone and between the first storage zone and the first storage zone outfeed conveyor.

Preferably the system comprises a moveable conveying means adapted to transport at least one stack or partial stack between the second storage zone infeed conveyor and the second storage zone and between the second storage zone and the second storage zone outfeed conveyor.

Preferably the container separating means comprises a container destacker, more preferably a stacker/destacker.

According to a second aspect of the present invention there is provided a container handling system for arranging containers to fulfil orders, the system comprising a controller for receiving a plurality of orders, conveying means for receiving containers and transporting the containers to an output location, a container store, container destacking means, container stacking means, and transfer apparatus operable to transport containers between the conveying means and the container store, wherein:

a) the controller arranges the transfer of a required number of full groups of containers to a destination area, each full group comprising a predetermined number of full stacks of containers, each full stack comprising a predetermined number of containers, wherein each full group of containers contains a single variety of product;

b) the controller identifies a partial group of containers required to complete the order and arranges the supply of the identified partial group to the output by:
i) if there are sufficient containers in the store to make up the partial group, activating the transfer apparatus to retrieve containers from the container store and transfer the retrieved containers to the conveying means, and then conveying the partial group to the output; or
ii) if there are insufficient containers in the store to make up the partial group, loading a full group of containers onto the loading location, conveying the full group of containers to the transfer apparatus, removing excess containers from the full group and placing the removed excess containers in the container store, wherein the remaining partial group is conveyed to the output location and then transferred to the destination area;

wherein the system stores excess containers which are arranged in full homogeneous stacks in a first zone of the container store and stores excess containers which are arranged in other than a full homogeneous stack in a second zone of the container store, wherein,

if the controller determines that any of the excess containers are required by a subsequent order, those containers are stored in a position which is selected based on a composition of the subsequent order.

Preferably, the controller determines that a plurality of the excess containers are required by the subsequent order and stores the plurality of excess containers in the second zone in the same stack.

Preferably, containers are stored in the second zone in rows of stacks and/or partial stacks.

Preferably the controller determines that one or more of the excess containers are required by the subsequent order and stores the one or more excess containers in the second zone in the same row as one or more other containers which are also required for the same subsequent order.

Preferably the controller determines that one or more of the excess containers are required by the subsequent order and stores the one or more excess containers in the second zone in a row which is immediately adjacent a row containing one or more other containers which are also required for the same subsequent order.

Preferably the conveying means comprises one or more of an endless conveyor, powered roller conveyor, gravity roller conveyor, automatically guided vehicle and/or forklift.

Preferably the transfer apparatus comprises at least one container store infeed conveyor and at least one container store outfeed conveyor.

Preferably the transfer apparatus comprises a moveable conveying means adapted to transport at least one stack or partial stack between the at least one container store infeed conveyor and the container store, and between the container store and the at least one container store outfeed conveyor.

Preferably the transfer apparatus comprises a first storage zone infeed conveyor, a first storage zone outfeed conveyor, a second storage zone infeed conveyor and a second storage zone outfeed conveyor.

Preferably the transfer apparatus comprises a moveable conveying means adapted to transport at least one stack or partial stack between the first storage zone infeed conveyor and the first storage zone and between the first storage zone and the first storage zone outfeed conveyor.

Preferably the transfer apparatus comprises a moveable conveying means adapted to transport at least one stack or partial stack between the second storage zone infeed conveyor and the second storage zone and between the second storage zone and the second storage zone outfeed conveyor.

Preferably the container handling system comprises a bulk store subsystem

According to a third aspect of the present invention there is provided a method of operating container handling equipment to fulfil an order, wherein the order is one of a plurality of orders, the method comprising:
receiving at least one full stack of containers on a conveying means, the at least one stack of containers comprising at least one container required to fulfil the order,
separating the at least one container required to fulfil the order from excess containers which are not required to fulfil the order, and conveying the at least one container required to fulfil the order to an output location;
determining whether one or more of the excess containers are required by a subsequent order, and
   for any excess containers which are required by the subsequent order, selecting a position in a storage zone to store the containers based on a composition of the subsequent order.

Preferably the method comprises storing containers in the storage zone in rows of stacks and/or partial stacks.

Preferably the method comprises determining whether the excess containers required by the subsequent order can be stored in the storage zone in a subsequent order stack, and the subsequent order stack can be stored in the storage zone adjacent another stack containing at least one container required for the same subsequent order, and if so, storing the plurality of excess containers in the storage zone in a subsequent order stack and storing the subsequent order stack in the storage zone adjacent another stack containing at least one container required for the same subsequent order.

Preferably the method comprises determining whether the excess containers required by the subsequent order can be stored in the storage zone in the same stack, and if so, storing the plurality of excess containers in the storage zone in the same stack.

Preferably the method comprises,

determining whether the excess containers required by the subsequent order can be stored in the storage zone in the same stack, and if so, storing the plurality of excess containers in the storage zone in the same stack,
the method further comprising, if the excess containers required by the subsequent order cannot be stored in the storage zone in the same stack, determining whether the excess containers can be stored in the same row of the storage zone as one or more other containers which are also required to fulfil the subsequent order, and if so, storing the excess containers in the same row of the storage zone as the one or more other containers which are also required to fulfil the subsequent order.

Preferably the method comprises,

determining whether the excess containers required by the subsequent order can be stored in the storage zone in the same stack, and if so, storing the plurality of excess containers in the storage zone in the same stack,
the method further comprising, if the excess containers required by the subsequent order cannot be stored in the storage zone in the same stack, determining whether the excess containers can be stored in the same row of the storage zone as one or more other containers which are also required to fulfil the subsequent order, and if so, storing the excess containers in the same row of the storage zone as the one or more other containers which are also required to fulfil the subsequent order,
the method further comprising, if the excess containers cannot be stored in the same row of the storage zone as one or more other containers which are also required to fulfil the subsequent order, determining whether the one or more excess containers in the storage zone can be stored in a row which is immediately adjacent a row containing one or more other containers which are also required for the same subsequent order, and if so, storing the one or more excess containers in a row which is immediately adjacent a row containing one or more other containers which are also required for the same subsequent order.

Preferably the method comprises,

determining whether the excess containers required by the subsequent order can be stored in the storage zone in the same stack, and if so, storing the plurality of excess containers in the storage zone in the same stack,
the method further comprising, if the excess containers required by the subsequent order cannot be stored in the storage zone in the same stack, determining whether the excess containers can be stored in the same row of the storage zone as one or more other containers which are also required to fulfil the subsequent order, and if so, storing the excess containers in the same row of the storage zone as the one or more other containers which are also required to fulfil the subsequent order,
the method further comprising, if the excess containers cannot be stored in the same row of the storage zone as one or more other containers which are also required to fulfil the subsequent order, determining whether the one or more excess containers in the storage zone can be stored in a row which is immediately adjacent a row containing one or more other containers which are also required for the same subsequent order, and if so, storing the one or more excess containers in a row which is immediately adjacent a row containing one or more other containers which are also required for the same subsequent order.

According to a fourth aspect of the present invention there is provided method of operating container handling equipment to fulfil a plurality of orders, the equipment comprising conveying means for transporting groups of containers to an output location, a container store, container stacking means, container destacking means, and transfer apparatus operable to transport containers between the conveying means and the container store, the method comprising providing containers required to fulfil the current order to the output by:

a) transferring a required number of full groups of containers to a destination area, each full group comprising a predetermined number of full stacks of containers, each full stack comprising a predetermined number of containers, wherein each full group of containers contains a single variety of product;

b) identifying a partial group of containers required to complete the order and supplying the identified partial group by:
i) if there are sufficient containers in the container store to make up the partial group, retrieving containers from the container store and transferring them to the conveying means, and then conveying the partial group to the output location, and then transferring the containers to the destination area; or
ii) if there are insufficient containers in the container store to make up the partial group, loading a full group of containers onto the conveying means, removing excess containers from the full group and placing the removed excess containers in the container store, and conveying the remaining partial group to the output location and then transferring the containers to the destination area; wherein the method further comprises;
storing excess containers which are arranged in full homogeneous stacks in a first zone of the container store and storing excess containers which are arranged in other than a full homogeneous stack in a second zone of the container store, the method further comprising determining whether one or more of the excess containers are required by a subsequent order, and if so, selecting a position in the second zone for one or more of the excess containers based on a composition of the subsequent order.

Preferably, the method comprises determining that a plurality of the excess containers are required by the subsequent order, and storing the plurality of excess containers in the second zone in the same stack.

Preferably, the method comprises storing containers in the second zone in rows of stacks and/or partial stacks.

Preferably the method comprises determining that one or more of the excess containers are required by the subsequent order, and storing the one or more excess containers in the second zone in the same row as one or more other containers which are also required for the same subsequent order.

Preferably the method comprises determining that one or more of the excess containers are required by the subsequent order and storing the one or more excess containers in the second zone in a row which is immediately adjacent a row containing one or more other containers which are also required for the same subsequent order.

Preferably the conveying means comprises one or more of an endless conveyor, powered roller conveyor, gravity roller conveyor, automatically guided vehicle and/or forklift.

Preferably the method comprises storing containers in the storage area in a plurality of rows.

Preferably the transfer apparatus comprises a first storage zone infeed conveyor, a first storage zone outfeed conveyor, a second storage zone infeed conveyor and a second storage zone outfeed conveyor.

Preferably the transfer apparatus comprises a moveable conveying means adapted to transport at least one stack or partial stack between the first storage zone infeed conveyor and the first storage zone and between the first storage zone and the first storage zone outfeed conveyor.

Preferably the transfer apparatus comprises a moveable conveying means adapted to transport at least one stack or partial stack between the second storage zone infeed conveyor and the second storage zone and between the second storage zone and the second storage zone outfeed conveyor.

Preferably the method comprises stacking together one or more excess containers which will be used to fulfil a subsequent order before the excess containers are stored in the second zone.

Preferably the method comprises storing a plurality of stacks of containers which will be used to fulfil a subsequent order immediately adjacent one another in the second storage zone.

Preferably the plurality of stacks of containers which will be used to fulfil a subsequent order are stored in the same row of the second storage zone.

Preferably the plurality of stacks of containers which will be used to fulfil a subsequent order are stored in immediately adjacent rows of the second storage.

Preferably the method comprises retrieving stacks or partial stacks from the storage area and combining one or more containers from the retrieved stacks or partial stacks with the excess containers, prior to the step of storing the excess containers in the second storage zone.

According to a further aspect of the present invention there is provided a computer program product for programming a controller of a container handling equipment system to operate the container handling equipment system to perform the method of the third or fourth aspects.

The invention may also be said broadly to consist in the parts, elements and features referred to or indicated in the specification of the application, individually or collectively, in any or all combinations of two or more of said parts, elements or features, and where specific integers are mentioned herein which have known equivalents in the art to which the invention relates, such known equivalents are deemed to be incorporated herein as if individually set forth.

According to a still further aspect of the present invention there is provided a container handling system and/or a method of operating a container handling system substantially as herein described, with reference to the accompanying drawing.

Further aspects of the invention, which should be considered in all its novel aspects, will become apparent from the following description given by way of example of possible embodiments of the invention.

### BRIEF DESCRIPTION OF THE DRAWINGS

FIG. 1 is a diagrammatic plan view of one embodiment of the invention.

FIG. 2 is a diagrammatic plan view of a bulk store subsystem of a second embodiment of the invention.

### BRIEF DESCRIPTION OF PREFERRED EMBODIMENTS

The present invention relates to a system for creating a set of containers which fulfils an order. Each container contains one or more items of a particular variety of product. A plurality of different types of product are available, and the order may include any number of any one or more of the different types of available product.

The system of the present invention has particular application where there are between around 12 and around 200 different types of product (SKUs) which an order can be selected from (for example retail milk products), more preferably between around 70 and 140 SKUs. The system is not intended for applications where an order may be selected from many hundreds or thousands of SKUs.

The invention has particular application to products which are stored in containers, and in particular to products stored in containers which are “self meshing” when stacked one on top of the other. Milk and bread are examples of such products.

One feature of such systems is that a central controller (typically a computer operating under the control of suitable computer program) typically receives a number of orders in advance of the order currently being processed.

The present invention utilises the fact that at the time the system is processing one order, the controller knows which containers will be needed to fulfil one or more future/subsequent orders. This allows the system to operate in a more efficient manner by including consideration of the requirements of the future or subsequent orders when processing the current order.

The purpose of the system is to, for each order, create a set of containers which contains the required number of each type of product to fulfil the order. The containers for each order are arranged into as many full stacks as possible (a full stack comprising a predetermined maximum number of containers stacked on top of one another) in order to minimise the floor space taken up by the containers, and to make transportation of the containers as efficient as possible. Under normal circumstances the set of containers produced by the system to fulfil a particular order will comprise some number of full stacks of containers (including zero full stacks in some cases), and no more than one partial stack of containers (a partial stack comprising a number of containers stacked on top of one another, where the number of containers is less than that in a full stack, and includes a single container).

Unless the context clearly requires otherwise, the term “stack” is a general term referring to a stack of containers consisting of no more than the predetermined number of containers in a full stack, and includes a single container.

The system moves the containers for a particular order to a destination area. The destination area may be the deck of a delivery vehicle, or it may be a “staging area” where the containers are stored prior to loading into the vehicle.

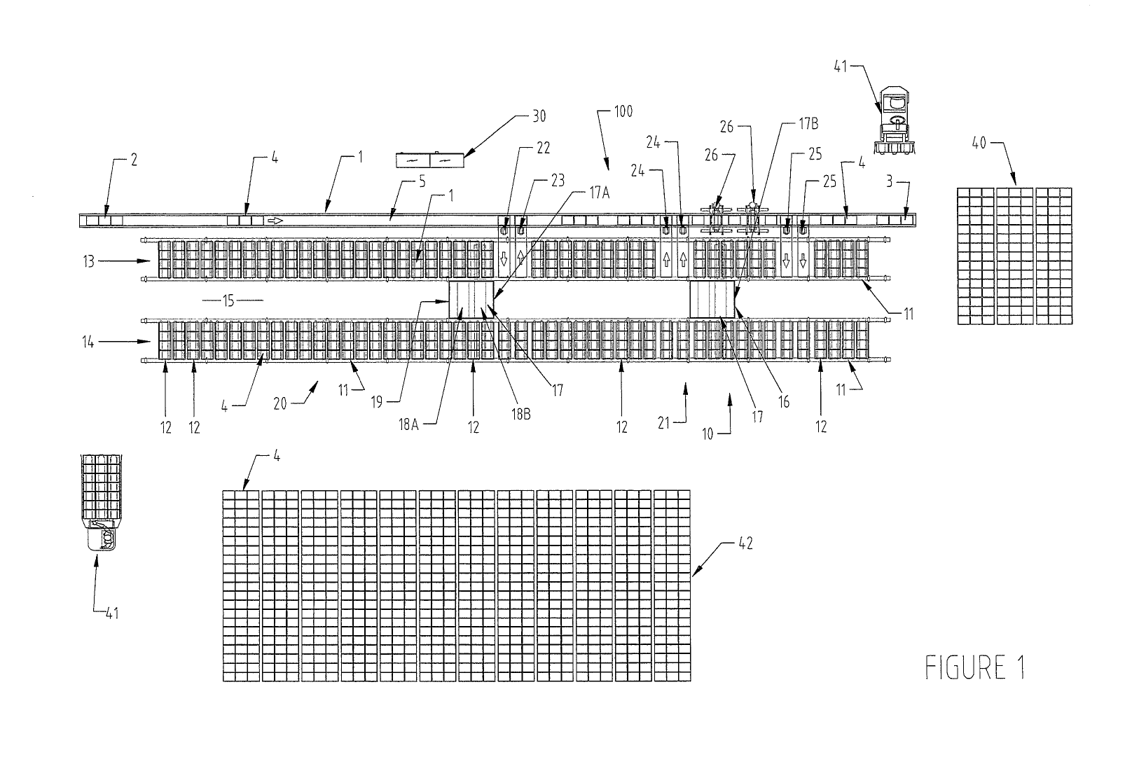

An exemplary system of the present invention is shown in FIG. 1 and is generally referenced 100.

The system comprises a main conveying means 1 having a loading location 2 at a first end and an unloading location 3 at a distal end to the loading location 2. In preferred embodiments the main conveying means 1 is configured to move containers 4 exclusively towards the unloading location 3, and may comprise (for example) at least one endless belt conveyor 5, powered roller conveyor, or gravity roller conveyor, or a plurality of these in combination. The conveying means 1 may additionally or alternatively comprise one or more forklifts and/or automatically guided vehicles.

The system 100 comprises a container storage zone 10. The container storage zone 10 is adjacent the main conveying means 1, preferably immediately adjacent.

The storage zone 10 comprises support means 11 configured to support containers 4, either alone or arranged into stacks. The support means 11 are configured to arrange the containers 4 in a plurality of adjacent and parallel rows 12 arranged in a first rank 13 and a substantially parallel and adjacent second rank 14 of rows 12. In the embodiment shown the rows 12 of containers in the ranks 13, 14 are substantially transverse to the first conveying means 1, and the ranks 13, 14 of rows are substantially parallel to the first conveying means 1. The first rank 13 is substantially adjacent the first conveying means 1, and the second rank 14 is spaced from the first rank 13 so as to leave an aisle 15 large enough for a container transport means 16 to move a plurality of stacks of containers along.

In a preferred embodiment the container transport means 16 comprises a moveable conveying means 17. The moveable conveying means is operable to move containers in a direction parallel to the rows 12 and can thereby move containers or stacks of containers to different positions within the rows 12. In this embodiment the support means 11 may be provided as elevated rails which are cantilevered at the opposite ends to the aisle 15, so as to provide a clear space beneath the support means for the moveable conveying means 17.

The moveable conveying means 17 is itself able to move parallel to the ranks 13, 14, thereby transporting any containers engaged with the conveying means 17 to any one of the rows 12. In the embodiment shown the ends (not shown) of the conveying means 17 move underneath the support means 11 when the conveying means 11 is moved in this way. Those skilled in the art will appreciate that any container engaged with the conveying means 17 must first be moved into the aisle space 15 before the conveying means 17 can be moved along the ranks 13, 14.

The moveable conveying means 17 preferably comprises a first conveyor 18 having at least three individually controllable conveyor segments. A conveyor segment (not shown) is provided underneath each rank 13, 14, and a central conveyor segment 19 is provided in the aisle space. The conveyor segments which are beneath the ranks are able to move vertically upward to engage with the containers or stacks in a selected row 12 when those containers are to be moved, and to move downward below the support means 11 before the moveable conveyor is moved along the rank to index with another row.

In a more preferred embodiment the moveable conveying means comprises two parallel conveyors 18A, 18B, each comprising three individually controllable conveyor segments. The parallel conveyors 18A, 18B are preferably arranged to allow the conveying means 17 to index with two adjacent rows of containers in each rank 13, 14 at the same time. In a more preferred embodiment, the system comprises two independent moveable conveying means 17A, 17B, each comprising two parallel conveyors as described above.

The container storage zone 10 is preferably divided into a first storage zone 20, in which full, homogeneous, stacks of containers are stored, and a second storage zone 21, in which full stacks or partial stacks may be stored, as is described further below. The second storage zone 21 is preferably closer to the unloading location 3 than the first storage zone 20.

A first storage zone infeed conveyor 22 and first storage zone outfeed conveyor 23 are provided which extend between the first storage zone 20 and the main conveyor 1. The first storage zone infeed conveyor 22 and first storage zone outfeed conveyor 23 are preferably substantially parallel and adjacent, and are operable independently of each other. The spacing between the first storage zone infeed conveyor 22 and first storage zone outfeed conveyor 23 is preferably selected to be the same as that between adjacent rows 12 in the storage zone 10, so that the moveable conveying means 17A, 17B can receive stacks of containers from the infeed conveyor 22 at the same time as it sends stacks of containers out of the first zone on the outfeed conveyor 23.

The second storage zone 21 is provided with at least one second storage zone outfeed conveyor 24, and more preferably two parallel and adjacent second storage zone outfeed conveyors 24. The second storage zone is also provided with at least one second storage zone infeed conveyor 25, and more preferably two parallel and adjacent second storage zone infeed conveyors 25, the infeed conveyors 25 being closer to the unloading location 3 than the outfeed conveyors 24. At least one container stacking/destacking means 26 is provided for the main conveyor 1 between the intersection of the main conveyor 1 with the second storage zone outfeed conveyor(s) 24 and the intersection of the main conveyor 1 with the second storage zone infeed conveyor(s) 25. The stacker/destacker 26 is capable of stacking a plurality of partial stacks and/or individual containers into one or more full stacks, and of destacking a full stack of containers into separate partial stacks or individual containers.

In use, the system controller 30 receives at least two orders, each order comprising a request for a selection of varieties of products as described above.

The controller 30 apportions the first order into varieties of product which:
i) are required in amounts equating to at least one full group of containers;
ii) are required in amounts equating to at least one full stack of containers (but less than a full group); and
iii) are required in amounts equating to less than a full stack.

Each full group or “frame” of containers consists of a predetermined number of full stacks of containers, each full stack comprising a predetermined number of containers, wherein each full group of containers contains a single variety of product. However, it is to be understood that term “group”, when not used in the context of a “full group” or “frame” of containers, or to a “partial group” or “partial frame”, simply refers to a collection of containers.

In embodiments in which each container 4 holds a plurality of items, the controller 30 may also apportion the order into varieties of product which are required in amounts of more than one item but less than one full container of items.

The controller satisfies the full frame component of the order by arranging the transfer of the required number of full frames of containers from a source of containers, for example a bulk or buffer storage area, to the destination area 40. In some embodiments the containers may be moved along the main conveyor, but in other embodiments a separate mechanism such as a forklift 41 or Automatically Guided Vehicle will move the containers 4 directly from a source of containers 42 to the destination area 40. In some embodiments the controller 30 may select on a case-by-case basis whether to use the main conveyor 1 or a separate mechanism. The controller 30 may control the forklift (if used) directly, or may simply provide instructions to a human operator to transfer the required containers to the destination area 40.

For varieties which are required in amounts of less than one full frame (including any remainder amounts of a variety which are still required after one or more full frames of that variety have been transferred), the system controller 30 checks whether a suitable number of containers of that variety is available in the storage zone 10. If so, the controller 30 operates the first and/or second moveable conveying means 17A, 17B to transfer at least the required number of containers from the storage zone 10 to the relevant outfeed conveyor 23, 24. The first stacker/destacker 26 stacks the containers received from the container store together into one or more full stacks. The stacker/destacker 26 may also remove any excess or unrequired containers from a stack or partial stack of containers which has been transferred out of the storage zone 10, for example if the number of containers in that stack or partial stack is greater than what is required by the order, or if the stack received from the storage zone 10 includes containers holding varieties of product which are not required. These excess containers are stored in the second storage zone 21, as is described further below.

If the controller 30 decides that a suitable amount of the required variety is not already available in the storage zone 10, it requests that a full frame of that variety of product be placed on the loading location 2 of the main conveyor 1. Any excess full stacks from the frame which are not required to satisfy the order are stored in the first storage zone 20.

Any unrequired containers of less than a full stack in number (i.e., partial stacks) are stored in the second storage zone 21.

In storing stacks in the second zone 21, the controller 30 attempts to obey the following hierarchy of rules or principles to the greatest extent possible:
1. Groups of containers required for the same future order are stored in the same stack, and a plurality of such stacks are stored physically adjacent each other in the second storage zone (either in the same row, or in adjacent rows).
2. Groups of containers required for the same future order are stored in the same stack.
3. Groups of containers required for the same future order are in stacks which are adjacent each other in the second storage zone (either in the same row, or in adjacent rows).
4. Groups of containers which are suitable for mixing with one or more homogeneous full stacks to create at least one stack which follows one of principles 1-3 are stored in the same stack.

By following these rules to the greatest extent possible, the system 100 reduces the amount of movement required of the second moveable conveying means 17 B in order to retrieve containers from the second storage zone 21 to fulfil orders.

In a preferred embodiment the system 100 may preferentially store containers which have been identified as useful for fulfilling one of the known future/subsequent orders together in a first group near to the storage zone outfeed conveyor 24. Containers which are stored in the second zone 21 and which have not been identified as useful for fulfilling a particular future or subsequent order may be stored together in a second group which is further away from the outfeed conveyor 24.

In some embodiments the controller 30 may identify that one or more containers have not been identified as useful for fulfilling a particular future order contain only varieties of product which are ordered relatively infrequently. In this case the containers may be stored at a location which is remote from the outfeed conveyor 24. In some cases such containers may be temporarily transferred to the first storage zone 20, if necessary, in order to free up space in the second storage zone 21 for more frequently selected varieties of product.

In some embodiments the controller 30 may analyse only the next order to be fulfilled when deciding whether it can create (and store) stacks in accordance with one or more of the four rules or principles described above. In other embodiments both the next order and the following order may be analysed, or the next order and the two following orders. However, the system will only consider as many subsequent orders as are necessary to ensure that all, or substantially all, of the containers in the second zone have been allocated to a particular order and/or that the forklifts 41 or other mechanisms which supply containers to the main conveyor 1 are fully utilised.

In an attempt to create stacks in accordance with the principles above, the system controller 30 may send one or more stacks and/or partial stacks (which are not required to fulfil the current order) out of the second zone 21 (via one or both of the second zone outfeed conveyors). These stacks or partial stacks may comprise containers which can be combined with containers received from the first storage zone 20 and/or the loading location 2 to create stacks or partial stacks which can be formed and/or stored in accordance with one of the principles.

By providing two adjacent second zone infeed conveyors 25 and a moveable conveying means with two parallel and adjacent conveyors, the system 100 has considerable flexibility to change the relative order of the stacks as they are put away in the second storage zone 21, for example by transferring stacks from both infeed conveyors 25 to the same conveyor of the moveable conveying means 17B in a required order.

Similarly, because the storage zone is divided into two ranks 13, 14, the stacks or partial stacks may be transferred onto the support means 11 in a “first on-first off” sequence (when storing containers in the second rank 14) or in a “last on-first off” sequence (when storing containers in the first rank 13). Of course, the moveable conveying means 17A, 17B may store some stacks or partial stacks in the first rank and others in the second rank.

Providing two adjacent second zone outfeed conveyors 24 also increases the options for selecting the order in which stacks or partial stacks from the second storage zone 21 are fed back to the main conveyor 1, and, if required, combined with homogenous full stacks.

In preferred embodiments the system does not fill the rows of the first and second storage zones 20, 21 to their maximum capacity. Instead, sufficient space is left in each row to allow containers to be transferred from the row directly opposite, if this is required to access a required variety of container. In this way each row can be used to store more than one variety of product.

In one embodiment each row in the first zone 20 may be capable of storing six stacks of containers, but may in practice only store 4 stacks, leaving space for up two stacks from the opposite row to be stored temporarily if required. In this embodiment a maximum of two stacks of two different varieties would be stored in each row.

Similarly, each row in the second zone 21 may be capable of holding up to 6 stacks, but each opposed pair of rows may hold a maximum of seven stacks, so that any stack held in that pair of rows can be accessed. For example, one row may hold only one stack while the opposite row stores six stacks, or the first row may hold three stacks while the opposite row holds four. This ensures that the required containers can be accessed by swapping containers between opposing rows, avoiding the need to move unwanted containers to adjacent rows.

In a preferred embodiment two container stacker/destackers 26 are provided between the second storage zone infeed conveyor(s) 25 and the second storage zone outfeed conveyor(s) 24. This allows one of the container stacker/destackers 26 to create a stack of containers which is required for the current order, while the other creates a stack which is to be stored in the second storage zone 21 (and is preferably created in accordance with one or more of the principles above).

Suitable container stacker/destackers 26 will be well known to those skilled in the art. One example is described in the applicant's published PCT specification WO2011/028136, the content of which is included herein in its entirety by reference.

Containers which are to be used for the current order are stacked by the container stacker/destacker 26 into full stacks before moving to the unloading location 3. In preferred embodiments a full frame of such stacks is accumulated at the loading location 3 before a suitable apparatus (such as a forklift 41 or AGV) transfers the stacks to the destination area 40.

A simplified example of the operation of the system is described below.

In the example, a full stack comprises six containers, and a frame comprises three full stacks (18 containers).

Before the system begins to process the orders, the container store 10 has the following stock.

### Container Store—Original State

| | Variety A | Variety B |
|---|---|---|
| First zone (stacks) | 2 | 1 |
| | (12 containers) | (6 containers) |
| Second zone | 0 | 0 |
| (containers) | | |

The system controller 30 receives a plurality of orders, as shown below:

### Orders

| | Variety A | Variety B |
|---|---|---|
| | (containers) | (containers) |
| Order No. 1 | 40 | 35 |
| Order No. 2 | 20 | 13 |

The controller 30 allocates the orders as follows:

### Order 1

| | Variety A | Variety B |
|---|---|---|
| Full frames | 2 | 1 |
| Full stacks | 0 | 2 |
| containers in partial stack | 4 | 5 |

### Order 2

| | Variety A | Variety B |
|---|---|---|
| Full frames | 1 | 0 |
| Full stacks | 0 | 2 |
| containers in partial stack | 2 | 1 |

To fulfil order 1, the system controller 30 checks the inventory of the container store 10 for stores of Variety A product. Since the amount of Variety A available in the container store (2 stacks/12 containers) is less than that required by Order 1 (40 containers), more product is required. The system signals that three full frames of Variety A are required from the container source 42.

Two of these frames (36 containers) are transferred directly to the destination area 40. Only four further containers (one partial stack) of Variety A are required by order 1. Accordingly, the system transfers the two excess full stacks of Variety A into the first storage zone 20. The excess stacks of Variety A are preferably stored in the same row as the Variety A product which is already in the first storage zone 20. If this row becomes full then any remaining Variety A product is preferably stored in an immediately adjacent row, or an immediately opposite row of the first storage zone 20.

The destacker 26 removes two containers from the remaining full stack to create a partial stack of four containers which moves to the unloading location 3, and a second partial stack of two containers which are to be stored in the second storage zone 21.

In determining where and how the two containers forming this excess partial stack should be stored, the system controller 30 checks whether these containers can be combined with an anticipated excess partial stack of Variety B containers to form a stack or partial stack which can be used to fulfil part of Order 2. The system determines that Order 2 will require two containers of Variety A and a single container of Variety B, and that a single excess container of Variety B will need to be stored after the required amount of Variety B has been brought into the system to fulfil Order 1. This single container of Variety B can be stacked on top of the two excess Variety A containers, to create a partial stack of containers which can be used in its entirety as part of fulfilling Order 2. Accordingly, the two containers of Variety A are withheld by the second destacking means 26, rather than being transferred immediately into the second storage zone 21.

The system controller 30 next checks the inventory of the container store 10 for stores of Variety B product. Since the amount of Variety B available in the container store 10 (1 stack/6 containers) is less than that required by Order 1 (35 containers), more product is required. The system signals that two full frames of Variety B are required from the container source 42. One of these frames (18 containers) is transferred directly to the destination area 40.

Two full stacks (12 containers) from the second frame of Variety B are transferred to the loading location 2 and move along the conveyor 1 to the unloading location 3. The destacking means 26 destacks the third stack into a partial stack of five containers, and a second (excess) partial stack of one container. The partial stack of five containers continues on to the unloading location 3, thereby completing Order 1. The one remaining Variety B container is added to the two containers of Variety A by the second destacker, and the resulting partial stack is stored in the second zone 21.

To fulfil Order 2, the system controller 30 checks the inventory of the container store 10 for stock of Variety A. There are now four full stacks of Variety A in the first storage zone 20 (the two original stacks, plus two excess stacks stored during the process of fulfilling Order 1). Accordingly, rather than require a full frame to be brought to the loading location 2, the system transfers three full stacks from the first storage zone 20 to the main conveying means 1. The three full stacks (18 containers) are transferred to the unloading location 3. The composite partial stack comprising two containers of Variety A and one of Variety B is transferred from the second storage zone 21 to the unloading location 3, thereby fulfilling the Variety A requirements of Order 2.

Order 2 further requires two full stacks of Variety B. Since the container store 10 still has only one full stack of Variety B containers in the first storage zone 20, a full frame of Variety B is transferred to the loading location 2. Two stacks from the frame are conveyed to the unloading location 3, while the excess stack from the frame is stored in the first storage zone 20, preferably in the same row of the first storage zone as the other stack of Variety B product.

Those skilled in the art will appreciate that the system 100 does not simply store high demand products in the first storage zone 20 and low demand products in the second storage zone 21. Instead, the zones 20, 21 are arranged to keep product which is required for the same future/subsequent order grouped together to the greatest extent possible, to minimise the area required to store the product, and to minimise the distance travelled by the transfer apparatus 17A, 17B, 22, 23, 24, 25 when retrieving containers from the container store 10.

While the preferred embodiment of the system described above has a first storage zone 20 and a second storage zone 21, each with its own infeed and outfeed conveyors and moveable conveying means, simplified embodiments of the invention may be employed. For example, a lower cost, lower throughput, embodiment of the system may employ a single outfeed conveyor (or pair of conveyors) to service both storage zones. Additionally or alternatively, only a single moveable conveying means may be provided to service both the first and second storage zones.

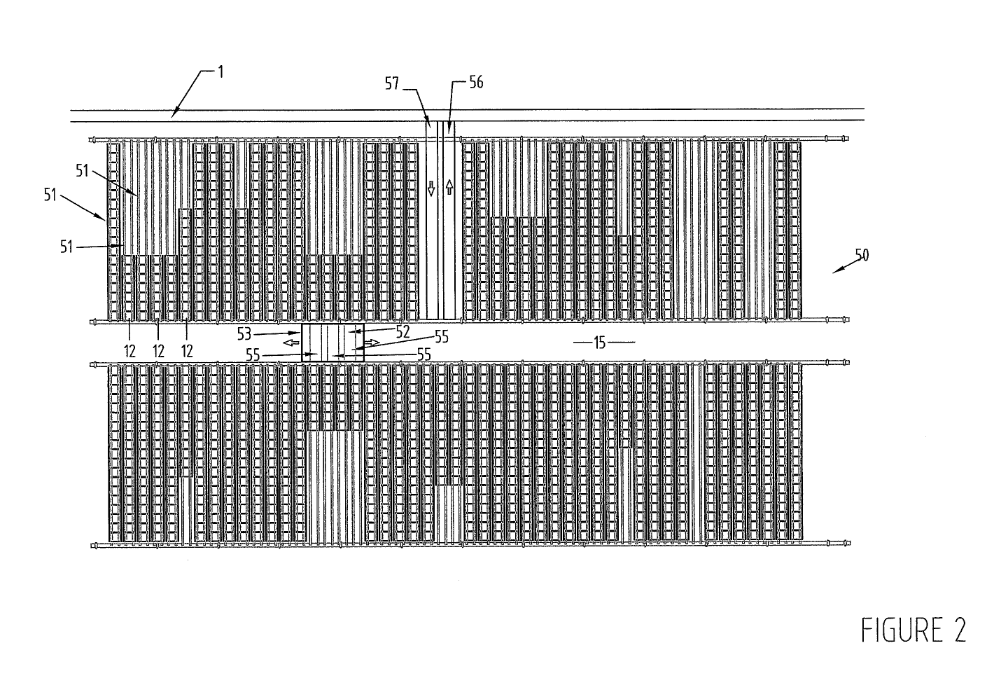

In the embodiment shown in FIG. 1, the source of containers 42 may simply be an area in which a large number of containers are stored prior to entering the container handling system 100. However, as shown in FIG. 2, in another embodiment the container handling system 100 may comprise an automated subsystem, generally referred to by arrow 50.

The bulk store subsystem 50 may comprise a similar arrangement of support means and moveable conveying means as the first and second storage zones 20, 21. However the support means 51 of the bulk store subsystem 50 are preferably adapted to hold a greater number of stacks in each row 12. In preferred embodiments the maximum number of stacks in each row 12 may exceed the number of stacks which can be carried by the central conveyor segment(s) 52 of the moveable conveyor 53. For example, in one embodiment each row 12 may comprise twenty stacks of containers, whereas each central conveyor segment 52 may have space for only three stacks. In this way the storage density in the bulk store subsystem 50 is maximised and the amount of empty space required for the aisle 15 is kept relatively low.

In a preferred embodiment the moveable conveying means 53 may be substantially identical to the moveable conveying means used in the first and second zones 20, 10. In some embodiments the moveable conveying means 53 may run on rails which extend into the first and second storage zones 10, 20 and are also used by the first and second moveable conveying means 17A, 17B.

In other embodiments the moveable conveying means 52 may be provided with more than two parallel conveyors 55, so as to increase the capacity of the moveable conveying means 53 without increasing the width of the aisle 15.

The bulk store subsystem 50 is intended to receive and store substantially all of the containers of product created. A conveyor, for example the main conveyor 1, may extend between an outfeed conveyor 56 of the bulk store subsystem 50 to the unloading location 3. In some embodiments the main conveyor 1 may also extend between the production line (not shown) and an infeed conveyor 57, although in alternative embodiments (not shown) a separate conveyor, possibly on the opposite side of the aisle 15 to the outfeed conveyor 56, may be used to supply containers to the bulk store subsystem 50.

In use, the bulk store subsystem 50 eliminates the need for forklifts 41 to supply the main conveyor 1, as is described above with reference to FIG. 1. When the controller determines that there are insufficient containers in the first and second zones 20, 21 to satisfy the current order, it controls the moveable conveyor 53 and outfeed conveyor 56 to move a full group of containers from the support means 51 to the main conveyor 1. In this embodiment a “full group” or “frame” of containers comprises the maximum number of containers which the moveable conveying means 53 can move along the aisle 15 in one operation. Once the full group of containers reaches the main conveyor 1 then the system 100 operates as described above. In addition to supplying full groups of containers, the bulk store subsystem may also retrieve single stacks of containers as required for supply to a unit picking subsystem (not shown). The unit picking subsystem is used to create containers having less than a full capacity of product and/or containers having two or more varieties of product.

In some embodiments the bulk store subsystem 50 may replace the first storage zone 20. However, in many embodiments it is preferred that the first storage zone 20 be retained in order to provide a buffer supply or “cache” of containers and thereby reduce any issues which may be caused by delays in the bulk store subsystem 50 providing the containers required to fulfil and order.

Those skilled in the art will appreciate that use of the bulk store subsystem 50 described above may substantially reduce the number of forklifts and/or AGVs required to operate the system.

In the embodiments described above the transfer means transfer means for transferring containers between the conveying means and the container store comprises the infeed and outfeed conveyors 22-25 and the moveable conveying means 17A, 17B. However, in other embodiments other transfer means may be used. For example, one or more of the infeed and outfeed conveyors 22-25 could be replaced by a suitable robot, for example a gantry robot. Similarly, one or more of the moveable conveying means could be replaced by a suitable robot. In such embodiments the support means 11 may not need to be arranged such that the conveying means 17 can pass under them. For example, the support means 11 could consist of raised portions on the floor (to allow easy access underneath lowermost container), or even just defined portions of the floor.

Although the embodiment above describes the use of a single bulk store subsystem 50 to supply containers for the first and second zones 20, 21, in alternative embodiments (not shown) a plurality of bulk store subsystems 50 may be used in parallel to supply a single first and second zone 20, 21.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

Where in the foregoing description, reference has been made to specific components or integers of the invention having known equivalents, then such equivalents are herein incorporated as if individually set forth.

Although this invention has been described by way of example and with reference to possible embodiments thereof, it is to be understood that modifications or improvements may be made thereto without departing from the spirit or scope of the appended claims.

1. A container handling system for arranging containers to fulfil a plurality of orders, the system comprising:
conveying means for receiving at least one full stack of containers, the at least one stack of containers comprising at least one container required to fulfil a first of the plurality of orders;
container separating means for separating the at least one container required to fulfil the first order from any excess containers which are not required to fulfil the first order, wherein the conveying means conveys the at least one container required to fulfil the first order to an output location;
a container store, and transfer means for transferring containers between the conveying means and the container store; and
a controller for receiving the plurality of orders and controlling the container separating means and the transfer means; wherein
the controller determines whether one or more of the excess containers are required by a subsequent order, and for any excess containers which are required by the subsequent order, selects a position in the container store to store the required excess containers based on a composition of the subsequent order.

2. The container handling system of claim 1 wherein containers are stored in the container store in rows of stacks and/or partial stacks.

3. The system of claim 2 wherein;
(i) if possible, the controller directs the transfer means to store a plurality of the excess containers required for the subsequent order together in a subsequent order stack, and to store the subsequent order stack adjacent another stack comprising containers required for the same subsequent order.

4. The system of claim 2 wherein;
(i) if possible, the controller directs the transfer means to store a plurality of the excess containers required for the subsequent order together in a subsequent order stack, and to store the subsequent order stack adjacent another stack comprising containers required for the same subsequent order; or
(ii) if (i) is not possible, the controller directs the transfer means to store a plurality of the excess containers required for the subsequent order together in a subsequent order stack.

5. The system of claim 2 wherein;
(i) if possible, the controller directs the transfer means to store a plurality of the excess containers required for the subsequent order together in a subsequent order stack, and to store the subsequent order stack adjacent another stack comprising containers required for the same subsequent order; or
(ii) if (i) is not possible, the controller directs the transfer means to store a plurality of the excess containers required for the subsequent order together in a subsequent order stack; or
(iii) if neither (i) or (ii) are possible, the controller directs the transfer means to store at least one of the excess containers required for the subsequent order in a stack which is adjacent another stack comprising containers required for the same subsequent order.

6. The system of claim 2 wherein;
(i) if possible, the controller directs the transfer means to store a plurality of the excess containers required for the subsequent order in a subsequent order stack, and to store the subsequent order stack adjacent another stack comprising containers required for the same subsequent order; or
(ii) if (i) is not possible, the controller directs the transfer means to store a plurality of the excess containers required for the subsequent order in a subsequent order stack; or
(iii) if neither (i) or (ii) are possible, the controller directs the transfer means to store at least one of the excess containers required for the subsequent order in a stack which is adjacent another stack comprising containers required for the same subsequent order; or
(iv) if neither of (i), (ii) or (iii) are possible, the controller, if possible, directs the transfer means to stack a plurality of the excess containers together which are suitable for mixing with one or more homogeneous full stacks to create at least one stack which can be stored in accordance with one of (i) to (iii).

7. The container handling system of claim 1, wherein excess containers which are not required for any of the plurality of orders are stored in the container store.

8. The container handing system of claim 7 wherein the transfer means comprises an outfeed conveyor for conveying containers out of the container store, wherein excess containers which are required for one of the plurality of orders are stored in a group, and excess containers which are not required for any of the plurality of orders are stored further away from the outfeed conveyor than excess containers which are required for one of the plurality of orders.

9. The container handling system of claim 7, wherein full stacks of excess containers which are not required for any of the plurality of orders are stored in a first zone of the container store, and partial stacks of excess containers which are not required for any of the plurality of orders are stored in a second zone of the container store along with excess containers which are required for a subsequent order, wherein the transfer means comprises a second storage zone outfeed conveyor for conveying containers out of the second zone, and wherein excess containers which are not required for any of the plurality of orders are stored further away from the outfeed conveyor than excess containers which are required for one of the plurality of orders.

10. The container handling system of claim 9 wherein the transfer means comprises a first storage zone infeed conveyor, a first storage zone outfeed conveyor and a second storage zone infeed conveyor.

11. The container handling system of claim 10 comprising a moveable conveying means adapted to transport at least one stack or partial stack between the first storage zone infeed conveyor and the first storage zone and between the first storage zone and the first storage zone outfeed conveyor.

12. The container handling system of claim 11 comprising a moveable conveying means adapted to transport at least one stack or partial stack between the second storage zone infeed conveyor and the second storage zone and between the second storage zone and the second storage zone outfeed conveyor.

13. A method of operating container handling equipment to fulfil an order, wherein the order is one of a plurality of orders, the method comprising:
i. receiving at least one full stack of containers on a conveying means, the at least one stack of containers comprising at least one container required to fulfil the order,
ii. separating the at least one container required to fulfil the order from excess containers which are not required to fulfil the order, and conveying the at least one container required to fulfil the order to an output location;
iii. determining whether one or more of the excess containers are required by a subsequent order, and
iv. for any excess containers which are required by the subsequent order, selecting a position in a storage zone to store the containers based on a composition of the subsequent order.

14. The method of claim 13 comprising storing containers in the storage zone in rows of stacks and/or partial stacks.

15. The method of claim 14 comprising determining whether the excess containers required by the subsequent order can be stored in the storage zone in a subsequent order stack, and the subsequent order stack can be stored in the storage zone adjacent another stack containing at least one container required for the same subsequent order, and if so, storing the plurality of excess containers in the storage zone in a subsequent order stack and storing the subsequent order stack in the storage zone adjacent another stack containing at least one container required for the same subsequent order.

16. The method of claim 14 comprising determining whether the excess containers required by the subsequent order can be stored in the storage zone in the same stack, and if so, storing the plurality of excess containers in the storage zone in the same stack.

17. The method of claim 14 further comprising:
determining whether the excess containers required by the subsequent order can be stored in the storage zone in the same stack, and if so, storing the plurality of excess containers in the storage zone in the same stack,
the method further comprising, if the excess containers required by the subsequent order cannot be stored in the storage zone in the same stack, determining whether the excess containers can be stored in the same row of the storage zone as one or more other containers which are also required to fulfil the subsequent order, and if so, storing the excess containers in the same row of the storage zone as the one or more other containers which are also required to fulfil the subsequent order.

18. The method of claim 14 further comprising:
determining whether the excess containers required by the subsequent order can be stored in the storage zone in the same stack, and if so, storing the plurality of excess containers in the storage zone in the same stack,
the method further comprising, if the excess containers required by the subsequent order cannot be stored in the storage zone in the same stack, determining whether the excess containers can be stored in the same row of the storage zone as one or more other containers which are also required to fulfil the subsequent order, and if so, storing the excess containers in the same row of the storage zone as the one or more other containers which are also required to fulfil the subsequent order,
the method further comprising, if the excess containers cannot be stored in the same row of the storage zone as one or more other containers which are also required to fulfil the subsequent order, determining whether the one or more excess containers in the storage zone can be stored in a row which is immediately adjacent a row containing one or more other containers which are also required for the same subsequent order, and if so, storing the one or more excess containers in a row which is immediately adjacent a row containing one or more other containers which are also required for the same subsequent order.

19. The method of claim 14 further comprising:
determining whether the excess containers required by the subsequent order can be stored in the storage zone in the same stack, and if so, storing the plurality of excess containers in the storage zone in the same stack,
the method further comprising, if the excess containers required by the subsequent order cannot be stored in the storage zone in the same stack, determining whether the excess containers can be stored in the same row of the storage zone as one or more other containers which are also required to fulfil the subsequent order, and if so, storing the excess containers in the same row of the storage zone as the one or more other containers which are also required to fulfil the subsequent order,
the method further comprising, if the excess containers cannot be stored in the same row of the storage zone as one or more other containers which are also required to fulfil the subsequent order, determining whether the one or more excess containers in the storage zone can be stored in a row which is immediately adjacent a row containing one or more other containers which are also required for the same subsequent order, and if so, storing the one or more excess containers in a row which is immediately adjacent a row containing one or more other containers which are also required for the same subsequent order.

20. A computer program product containing a set of instructions for programming a controller of a container handling equipment system to operate the container handling equipment system to perform the method of claim 13.

21. (canceled)
